(19) United States
(12) Patent Application Publication
(10) Pub. No.: US 2021/0119481 A1
(43) Pub. Date: Apr. 22, 2021

(54) INTELLIGENT OFF-PEAK POWER DISTRIBUTION SYSTEM

(71) Applicants: Austin Lai, Taichung City (TW); Kuan-Ching Lee, Taichung City (TW); Hong-Min Chen, Taichung City (TW); Kai-Yang Cheng, Taichung City (TW); Wei-Fu Hsu, Taichung City (TW); Hui-Ping Yang, Taichung City (TW); Ya-Ling Lien, Taichung City (TW)

(72) Inventors: Austin Lai, Taichung City (TW); Kuan-Ching Lee, Taichung City (TW); Hong-Min Chen, Taichung City (TW); Kai-Yang Cheng, Taichung City (TW); Wei-Fu Hsu, Taichung City (TW); Hui-Ping Yang, Taichung City (TW); Ya-Ling Lien, Taichung City (TW)

(73) Assignee: AVERTRONICS INC., Taichung City (TW)

(21) Appl. No.: 16/660,711

(22) Filed: Oct. 22, 2019

(51) Int. Cl. H02J 13/00; H02J 7/00; H02J 9/06; H05B 37/02

(52) U.S. Cl. CPC H02J 13/0003; H02J 7/0021; B60P 3/00; H05B 37/0209; H02J 9/061

(57) ABSTRACT

An intelligent off-peak power distribution system may include a plurality of power consumption ends powered by a plurality of batteries. Each of the batteries is individually programmed with an electronic code, and the batteries are charged by at least a power supply end, and the charging method thereof is to use off-peak power to perform charging during off-peak hour. At least a distribution vehicle is provided to transport the batteries between the power consumption ends and the power supply end, and a smart communication network is communicated with the power consumption ends, the distribution vehicle, and the power supply end. The batteries are available and transported between the power consumption ends by the distribution vehicle so that the distribution vehicle departing from the power supply end is configured to distribute power to more power consumption ends in a single ride, thereby reducing the power and transportation costs.

### FIELD OF THE INVENTION

The present invention relates to a power supply system and more particularly to a low-cost intelligent off-peak power distribution system for a power consumption end that is not connected to the mains power transmission network.

### BACKGROUND OF THE INVENTION

At present, most areas are equipped with mains power transmission network that can provide stable power supply for households and public utilities. However, the mains power transmission network does not cover all areas such as mountain, mining area, and seaside, and also there have some places that just need temporary or periodic electricity utilization, which is obviously not economical like large delivery warehouse, parking lot around concert, temporary outdoor activities, mining, road repairing, emergency rescue, and natural disaster. The situations mentioned above commonly use trailer light tower for providing lighting when sunlight is insufficient. The trailer light tower is typically powered by diesel generator on site and is cooperated with a battery that can save and provide power when needed.

However, the conventional power supply system has following disadvantages: the construction of diesel generator is high cost, and a user needs to be at the site to fuel diesel and to do on/off operation for the diesel generator every time so as to control power generation, which is inconvenient to use and increases the management cost. Moreover, when the diesel generator is in operation, it will make noise, vibration, and exhaust gas, which leads to restrictions on the location where the light tower can be used. Therefore, there remains a need for a new and improved design for an intelligent off-peak power distribution system to overcome the problems presented above.

### SUMMARY OF THE INVENTION

The present invention provides an intelligent off-peak power distribution system which comprises a plurality of power consumption ends which are powered by a plurality of batteries. Each of the batteries is individually programmed with an electronic code, and the batteries are charged by at least a power supply end, and the charging method thereof is to use off-peak power to perform charging during off-peak hour. At least a distribution vehicle is provided to transport the batteries between the power consumption ends and the power supply end. A smart communication network is communicated with the power consumption ends, the distribution vehicle, and the power supply end, and the smart communication network is adapted to immediately update the information including the locations and the battery levels of the batteries, the location and distribution path of the distribution vehicle, and the total remaining power of the power consumption ends, so as to calculate and obtain the power distribution planning of the distribution vehicle including the arrival time, the distribution path, and the total amount of needed power for each power consumption end. The locations of the batteries are arranged as a loop among being used at the power consumption ends, being transported by the distribution vehicle, and being charged at the power supply end, and the smart communication network is adapted to monitor the current power amount of each battery through the electronic code. The total remaining power of the power consumption end includes the backup power and the power to be used, and the value of the backup power is that the full load power consumption of the power consumption end is multiplied by the sum of distribution distances, and the value of the power to be used is that the average daily power consumption of the power consumption end is multiplied by the sum of distribution distances. When the power to be used of the power consumption end is lower than a threshold value and needs to be replenished, the smart communication network is adapted to immediately arrange a power distribution planning and adjust the distribution path of the distribution vehicle that the distribution vehicle, which is adjacent to or will pass through the location that needs power supply, is configured to bring the backup power from other power consumption ends or to directly transport the batteries from the power supply end to the location. The power distribution planning enables the batteries which are at full power or at any power level to be available and transported between the power consumption ends so that the distribution vehicle departing from the power supply end is configured to distribute power to more power consumption ends in a single ride, thereby reducing the power and transportation costs. The intelligent off-peak power distribution system enables the power consumption ends which are not connected to the mains power transmission network to obtain power with lower costs, and the intelligent off-peak power distribution system will not generate noise and air pollution caused by on-site fuel power generation, so as to provide economical and effective power distribution operation.

### BRIEF DESCRIPTION OF THE DRAWINGS

FIG. 1 is a schematic diagram of the operating structure of an intelligent off-peak power distribution system of the present invention.

FIG. 2 is a schematic view of an electricity cabinet of the intelligent off-peak power distribution system of the present invention.

FIG. 3 is a schematic view of a trailer light tower of the intelligent off-peak power distribution system of the present invention.

FIG. 4 is a schematic view illustrating a lighting fixture of the intelligent off-peak power distribution system of the present invention is in use.

FIG. 5 is a schematic view illustrating a charging plug of a distribution vehicle of the intelligent off-peak power distribution system of the present invention is in use.

FIG. 6 is a first schematic view of the distribution path of the distribution vehicle of the intelligent off-peak power distribution system of the present invention.

FIG. 7 is a second schematic view of the distribution path of the distribution vehicle of the intelligent off-peak power distribution system of the present invention.

FIG. 8 is a third schematic view of the distribution path of the distribution vehicle of the intelligent off-peak power distribution system of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

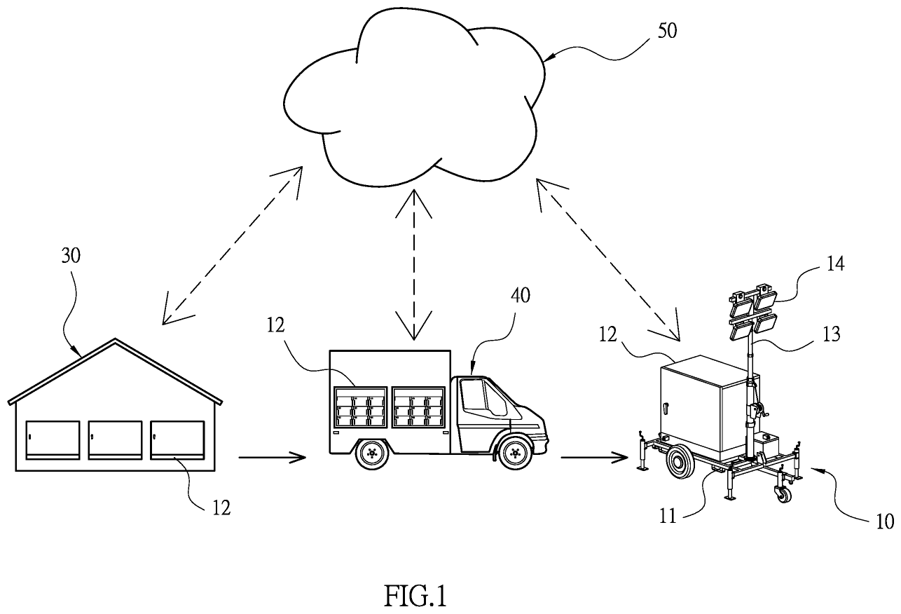

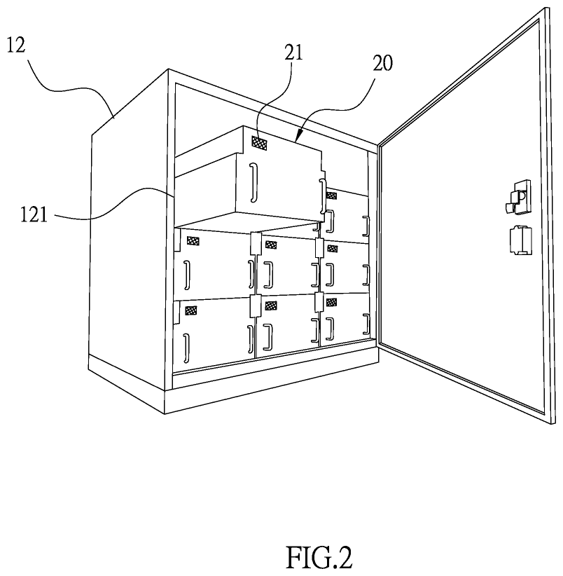

Referring to FIGS. 1 and 2, the present invention provides an intelligent off-peak power distribution system which comprises a plurality of power consumption ends (10) which are powered by a plurality of batteries (20) at the same time. Each of the batteries (20) is individually programmed with an electronic code (21), and the batteries (20) are charged by at least a power supply end (30), and the charging method thereof is to use off-peak power to perform charging during off-peak hour. At least a distribution vehicle (40) is provided to transport the batteries (20) between the power consumption ends (10) and the power supply end (30). A smart communication network (50) is communicated with the power consumption ends (10), the distribution vehicle (40), and the power supply end (30), and the smart communication network (50) is adapted to immediately update the information including the locations and the battery levels of the batteries (20), the location and distribution path of the distribution vehicle (40), and the total remaining power of the power consumption ends (10), so as to calculate and obtain the power distribution planning of the distribution vehicle (40) including the arrival time, the distribution path, and the total amount of needed power for each power consumption end (10). The locations of the batteries (20) are arranged as a loop among being used at the power consumption ends (10), being transported by the distribution vehicle (40), and being charged at the power supply end (30), and the smart communication network (50) is adapted to monitor the current power amount of each battery (20) through the electronic code (21). The total remaining power of the power consumption end (10) includes the backup power and the power to be used, and the value of the backup power is that the full load power consumption of the power consumption end (10) is multiplied by the sum of distribution distances, and the value of the power to be used is that the average daily power consumption of the power consumption end (10) is multiplied by the sum of distribution distances. When the power to be used of the power consumption end (10) is lower than a threshold value and needs to be replenished, the smart communication network (50) is adapted to immediately arrange a power distribution planning and adjust the distribution path of the distribution vehicle (40) that the distribution vehicle (40), which is adjacent to or will pass through the location that needs power supply, is configured to bring the backup power from other power consumption ends (10) or to directly transport the batteries (20) from the power supply end (30) to the location. The power distribution planning enables the batteries (20) which are at full power or at any power level to be available and transported between the power consumption ends (10) so that the distribution vehicle (40) departing from the power supply end (30) is configured to distribute power to more power consumption ends (10) in a single ride, thereby reducing the power and transportation costs. In addition, when the total remaining power of the power consumption end (10) is lower than a preset proportion such as 50% of the full load power (could be adjusted depending on distribution distance), the power-saving mode of the power consumption end (10) is automatically triggered, or the power-saving mode of the power consumption end (10) is started by the smart communication network (50) after the smart communication network (50) estimates the arrival time of the distribution vehicle (40). The power-saving mode is adapted to reduce each power load of the power consumption end (10) or to rest partial power loads of the power consumption end (10), and the power saving mode is configured to extend the service time of the power consumption end (10). Thus, the distribution vehicle (40) is adapted to have plenty of time to adjust the distribution planning so as to enable the power consumption ends (10) which are not connected to the mains power transmission network to obtain power with lower costs including power consumption cost and construction cost. Also, the intelligent off-peak power distribution system of the present invention will not generate noise and air pollution caused by on-site fuel power generation, so as to provide economical and effective power distribution operation.

The full load power consumption of the power consumption end (10) refers to the amount of power consumed by all loads at the power consumption end (10) when operating at full power throughout the day, and the sum of distribution distances refers to the distances between the power supply end (30) and the power consumption end (10) divides by hours. For example, when the distance between the power consumption end (10) and the power supply end (30) is one day drive, the backup power of the power consumption end (10) is two times of the amount of full load power consumption of the power consumption end (10) so as to increase the error tolerance of estimated delivery time to the power consumption end (10) and to provide the mutual support of the power consumption ends (10), thereby achieving efficient power distribution operation of the batteries (20). The power distribution planning is to calculate the total remaining power and the power needed to be replenished of the power consumption ends (10) until the next delivery, and the power needed to be replenished of the power consumption ends (10) is not limited to the amount of the batteries (20) but the total power combination of any number of the batteries (20) at full or any percentage. The replenished power for the power consumption ends (10) is adjusted according to the best load volume and the best distribution path of the distribution vehicle (40) per ride. Also, the calculation of the smart communication network (50) is configured to obtain the total amount of power of a batteries (20) instead of the total number of the batteries (20). Moreover, each of the batteries (20) corresponds to one electronic code (21), so that the batteries (20) which are positioned in an electricity cabinet (12) at the power consumption end (10) are adapted to be effectively replaced and the operation time for the distribution vehicle (40) to replace the batteries (20) is reduced, thereby improving the overall distribution efficiency.

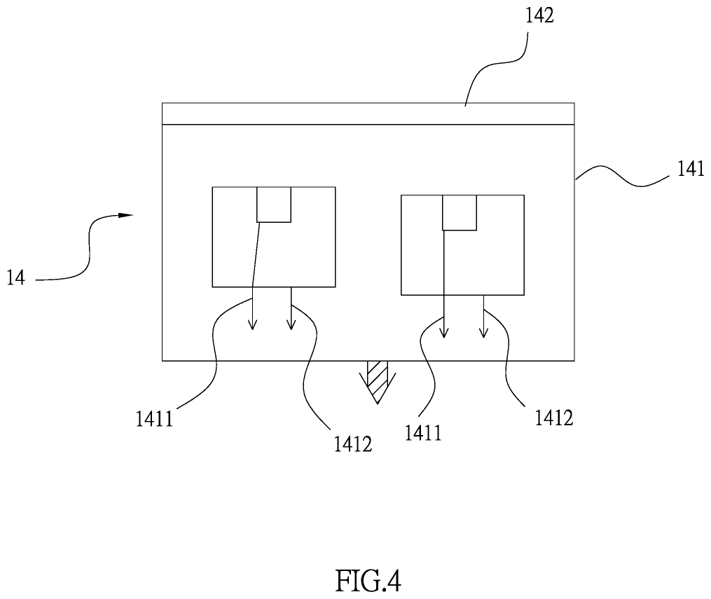

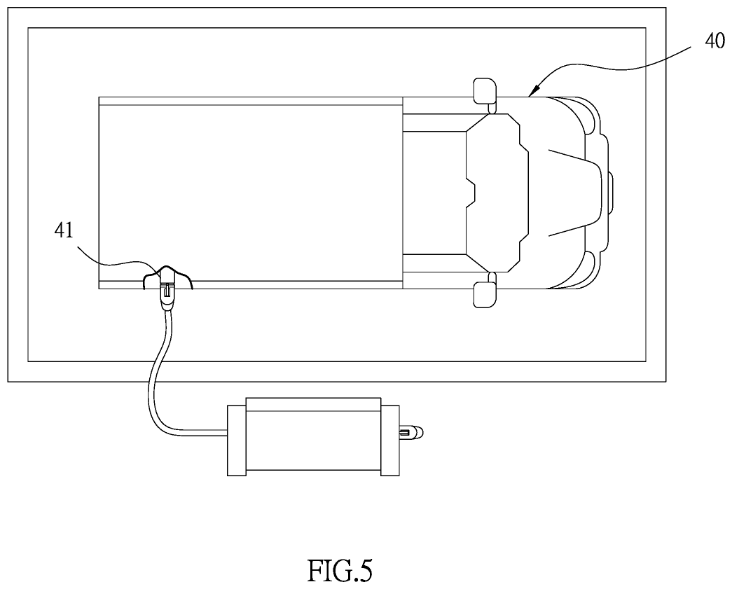

Referring to FIGS. 1 to 3, the power consumption end (10) is a trailer light tower which comprises a vehicle body (11), at least one electricity cabinet (12), a light post (13), and a plurality of lighting fixtures (14). The electricity cabinet (12) and the light post (13) are installed on the vehicle body (11), and the lighting fixtures (14) are secured at a top end of the light post (13). The electricity cabinet (12) has a space therein which is divided into a plurality of compartments (121) to respectively accommodate and electrically connect to the batteries (20). FIG. 2 shows an embodiment in the present invention, wherein the arrangement of the compartments (121) in the electricity cabinet (12) is three by three so as to accommodate and connect to nine batteries (20). The batteries (20) in the electricity cabinet (12) are adapted to provide power to the lighting fixtures (14) for illumination. The batteries (20) are one or combination of LiNiO₂ battery, LiNi_{0.8}Co_{0.2}O₂ battery, LiMnO₄ battery, LiNi_{0.3}Co_{0.3}Mn_{0.3}O₂ battery, and LiFePO₄ battery, and the voltage of the battery (20) is one or combination of 12V, 24V, and 48V. When in use, the batteries (20) mixed with different voltages and types are adapted to complete boost voltage, drop voltage, and voltage regulation through the electricity cabinet (12). Referring FIG. 4, the lighting fixture (14) comprises a luminous module (141) and a control unit (142), and the control unit (142) is configured to switch the light emitted by the luminous module (141) between a first light beam (1411) and a second light beam (1412). In addition, the circadian stimulus/photometry (CS/P) of the second light beam (1412) is smaller than that of the first light beam (1411), and the color temperature of the second light beam (1412) is essentially the same as that of the first light beam (1411). Furthermore, At least one wavelength peak of the first light beam (1411) is between 420 nm and 480 nm, and at least one wavelength peak of the second light beam (1412) is between 480 nm and 540 nm. The luminous module (141) is adapted to, according to the actual environment, time and purpose, select the wavelength of light source, which provides different CS/P, so as to provide sufficient light source for the user and maintain the user's physiological status without letting the user to aware that the color temperature of the light is changed. For instance, the light source with higher CS/P is provided to keep people refreshed, or the light source with lower CS/P is provided to make people feel warm and comfortable. Each of the distribution vehicle (40) and the power supply end (30) has a plurality of electricity cabinets (12), and the distribution vehicle (40) is adapted to record or transmit the information of the power levels of the batteries (20) through the electricity cabinet (12). Additionally, the distribution vehicle (40) is equipped with a GPS system that is configured to locate the distribution vehicle (40) and transmit the information of power levels of the batteries (20) obtained through the corresponding electronic codes (21) and the location of the distribution vehicle (40) to the smart communication network (50). Also, the batteries (20) are charged by the power supply end (30) through the electricity cabinet (12), and the electricity cabinet (12) is configured to be moved and replaced among the power consumption ends (10), the distribution vehicle (40), and the power supply end (30). Referring to FIG. 5, the distribution vehicle (40) has a charging base (41) which is adapted to electrically connect to the electricity cabinet (12) loaded on the distribution vehicle (40), and the charging base (41) is configured to directly charge all of the batteries (20) in the electricity cabinet (12). Moreover, the distribution vehicle (40) is adapted to externally connect to a charging plug through the charging base (41) for emergency charging and off-peak charging, and the charging plug is configured to be set in a relay charging station which provides a place for the distribution vehicle (40) to charge the batteries (20) during distribution. Also, the charging plug is adapted to be set in the house of deliverer to perform off-peak charging at night.

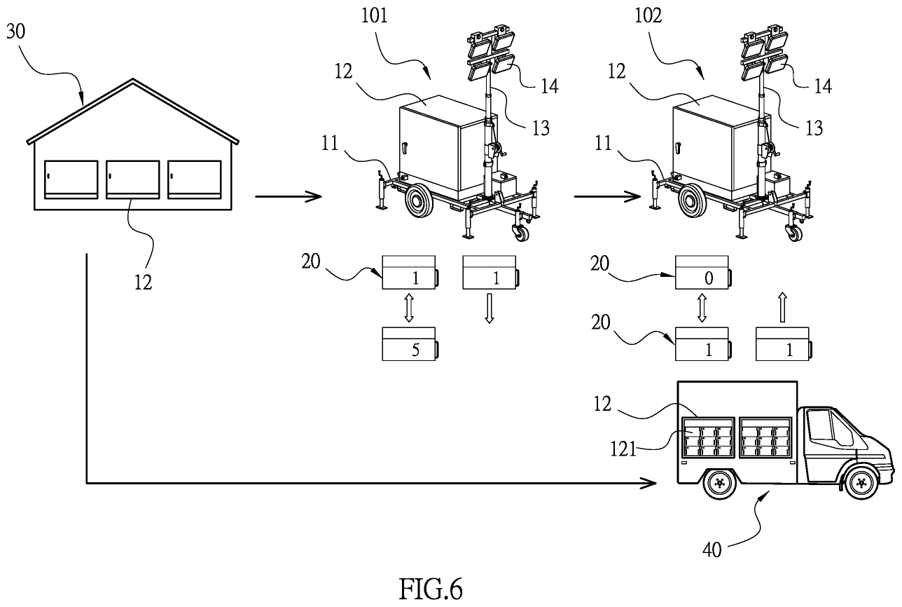

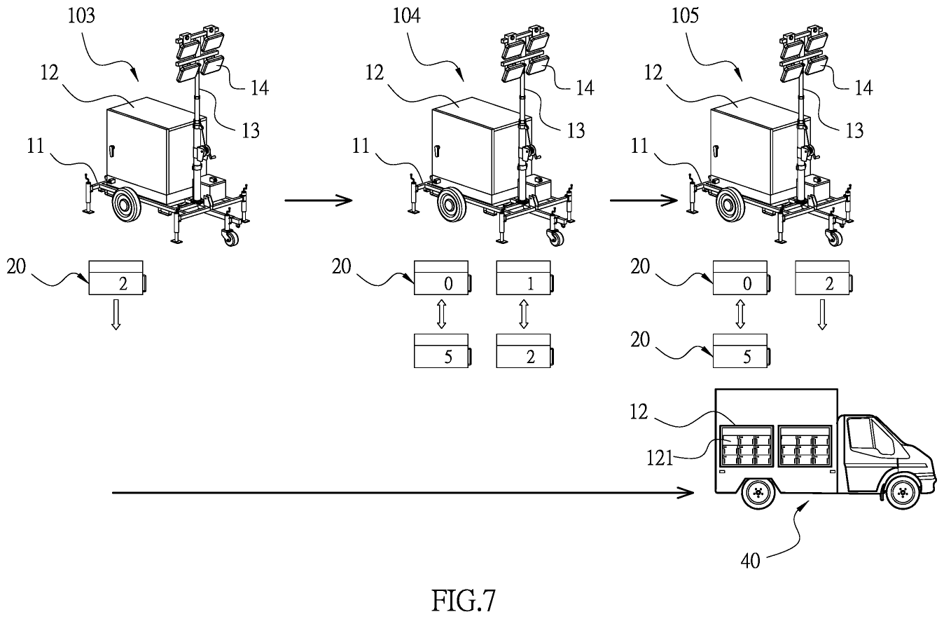

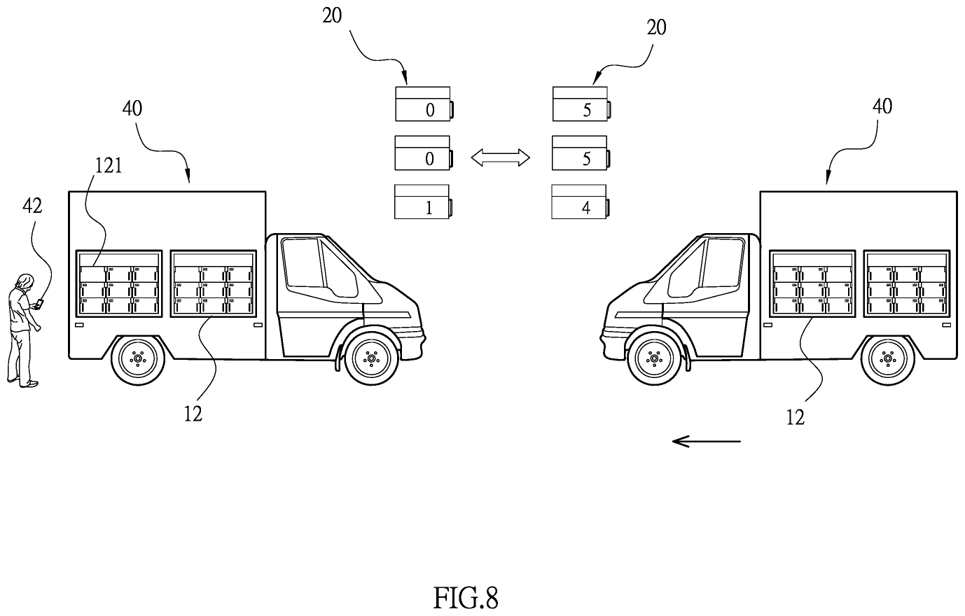

More specifically to explain the operation process, referring to FIGS. 1, 2 and 6, the smart communication network (50) is configured to keep collecting the use information and locations of the batteries (20) that are located among the power consumption ends (10), the distribution vehicle (40), and the power supply end (30). In addition, the smart communication network (50) is adapted to plan the distribution path of the distribution vehicle (40) according to the driving path of the distribution vehicle (40) and the amount of replenished powers needed by the power consumption ends (10) such that the distribution vehicle (40) is configured to be fully loaded with the required batteries (20) when departing from the power supply end (30) and also to reserve space to pick up the batteries (20) which are out of power. The amount of the batteries (20) carried by the distribution vehicle (40) is not limited to the day requirement. The batteries (20) needed to be delivered on the next day is adapted to be loaded on the distribution vehicle (40) when the distribution vehicle (40) still has space, thereby reducing the number of times that the distribution vehicle (40) needs to return to the power supply end (30). In the specific description, in case that the battery (20) from full power to no power is 5 units to 0 unit of power. The distribution vehicle (40) which is loaded with the full power of the batteries (20) departs from the power supply end (30) to a first power consumption end (101) that needs 3 units of power, the distribution vehicle (40) is adapted to provide 5 units of power and retrieve two of 1 units of power. Then, when the distribution vehicle (40) follows the distribution path provided by the smart communication network (50) to arrive a second power consumption end (102) which is adjacent to the original delivery route of the distribution vehicle (40) and needs 2 units of power. The smart communication network (50) is configured to guide the distribution vehicle (40) to provide the two of 1 units of power retrieved from the first power consumption end (101) to the second power consumption end (102), and the distribution vehicle (40) is adapted to retrieve the battery (20) which is out of power from the second power consumption end (102). Referring to FIG. 7, when the distribution vehicle (40) moves on and arrives a third power consumption end (103) which uses the amount of power lower than the average daily consumption. Thus, the distribution vehicle (40) is adapted to collect excess 2 units of power from the third power consumption end (103) so as to provide following power consumption ends for replacement. Similarly, the distribution vehicle (40) is configured to provide or collect excess power at a fourth power consumption end (104) and a fifth power consumption end (105), so that with the immediate power distribution planning provided by the smart communication network (50), the distribution vehicle (40) having a fixed carrying capacity is configured to provide power to more power consumption ends, which enables any delivery driver to efficiently complete distribution works. Furthermore, with the smart communication network (50), multiple delivery drivers can use the same distribution vehicle (40) to complete distribution works, which reduces the costs of delivery and management. In addition, referring FIG. 8, with the smart communication network (50) cooperating GPS installed on the distribution vehicle (40), multiple distribution vehicles (40) can work at the same time for mutual support. For example, two distribution vehicles (40) can follow the instruction provided by the smart communication network (50) to meet at a designated place and exchange the batteries (20) so as to reduce the number of times that the distribution vehicle (40) returns to the power supply end (30). Additionally, the batteries (20) needed to be recharged or the batteries (20) and the electricity cabinet (12) needed to be fixed can be collected in the same distribution vehicle (40) so as to be carried back to the power supply end (30) together.

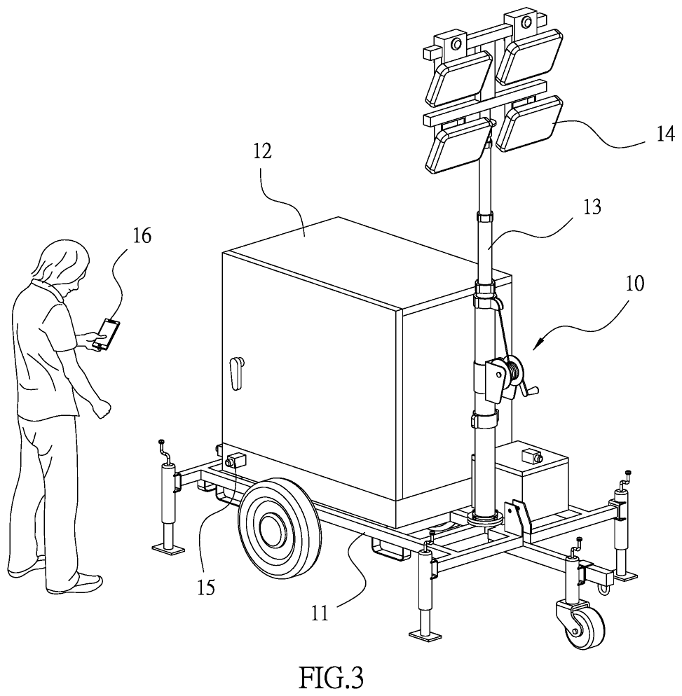

Referring to FIG. 3, at least a monitoring device (15) secured on the vehicle body (11) of the power consumption end (10) is set to start when capturing the dynamic picture or is cooperated with a sensor to automatically start when the battery (20) is pulled off from or connected to the electricity cabinet (12). The captured images are instantly sent to the smart communication network (50) so as to enable the smart communication network (50) to obtain real-time circumstance, sound alert, and save information synchronously. Moreover, the alert is sounded immediately when the monitoring device (15) is damaged and shut down, so as to achieve the anti-theft effect of the power consumption end (10). When the monitoring device (15) is damaged, the smart communication network (50) is adapted to immediately send and provide repair instruction to the distribution vehicle (40) so as to carry out the repair in the shortest time. Also, the above replacement and maintenance will establish a maintenance record in the smart communication network (50), which can improve the adjustment of parts inventory and effectively maintain high-quality of use of the power consumption end (10). In addition, the power consumption end (10) comprises a smart mobile device (16) which is communicated with the smart communication network (50) to display real-time power information and provide special offer to the user. Furthermore, the user can purchase, reduce, add, and cancel power use through the smart mobile device (16), and also the user can perform functions including instant messaging, online payment, and monitor screen watching through the smart mobile device (16). Referring to FIG. 8, the distribution vehicle (40) comprises a smart electronic device (42) which is communicated with the smart communication network (50) to display the instant driving path and the estimated arrival time of the distribution vehicle (40), and the amount of the batteries (20) needed by each power consumption end (10). At the same time, the smart electronic device (42) is communicated with the smart mobile device (16) in real-time so as to efficiently complete distribution works.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An intelligent off-peak power distribution system comprising a plurality of power consumption ends which are powered by a plurality of batteries; each of the batteries individually programmed with an electronic code, and the batteries charged by at least a power supply end, and the charging method thereof being to use off-peak power to perform charging during off-peak hour; at least a distribution vehicle provided to transport the batteries between the power consumption ends and the power supply end; a smart communication network, which is communicated with the power consumption ends, the distribution vehicle, and the power supply end, adapted to immediately update the information including the locations and the battery levels of the batteries, the location and distribution path of the distribution vehicle, and the total remaining power of the power consumption ends, so as to calculate and obtain the power distribution planning of the distribution vehicle including the arrival time, the distribution path, and the total amount of needed power for each power consumption end; the power distribution planning enabling the batteries which are at full power or at any power level to be available and transported between the power consumption ends so that the distribution vehicle, which departs from the power supply end, configured to distribute power to more power consumption ends in a single ride, thereby reducing the power and transportation costs; the power consumption ends, which are not connected to the mains power transmission network, configured to obtain power with lower cost and without noise and air pollution caused by on-site fuel power generation.

2. The intelligent off-peak power distribution system of claim 1, wherein the locations of the batteries are arranged as a loop among being used at the power consumption ends, being transported by the distribution vehicle, and being charged at the power supply end, and the smart communication network is adapted to monitor the current power amount of each battery through the corresponding electronic code; the total remaining power of the power consumption end includes the backup power and the power to be used, and the value of the backup power is that the full load power consumption of the power consumption end is multiplied by the sum of distribution distances, and the value of the power to be used is that the average daily power consumption of the power consumption end is multiplied by the sum of distribution distances; when the power to be used of the power consumption end is lower than a threshold value and needs to be replenished, the smart communication network is adapted to immediately arrange a power distribution planning and adjust the distribution path of the distribution vehicle that the distribution vehicle, which is adjacent to or will pass through the location that needs power supply, is configured to bring the backup power from other power consumption ends or to directly transport the batteries from the power supply end to the location.

3. The intelligent off-peak power distribution system of claim 2, wherein the power consumption end is a trailer light tower which comprises a vehicle body, at least one electricity cabinet, a light post, and a plurality of lighting fixtures; the electricity cabinet and the light post are installed on the vehicle body, and the lighting fixtures are secured at a top end of the light post; the electricity cabinet has a space therein which is divided into a plurality of compartments to respectively accommodate and electrically connect to the batteries, and the batteries in the electricity cabinet are adapted to provide power to the lighting fixtures for illumination.

4. The intelligent off-peak power distribution system of claim 3, wherein at least a monitoring device secured on the vehicle body of the power consumption end is set to start when capturing the dynamic picture or is cooperated with a sensor to automatically start when the battery is pulled off from or connected to the electricity cabinet; the captured images are instantly sent to the smart communication network so as to enable the smart communication network to obtain real-time circumstance, sound alert, and save information synchronously.

5. The intelligent off-peak power distribution system of claim 4, wherein the power consumption end comprises a smart mobile device which is communicated with the smart communication network to display real-time power information and provide special offer to the user; the user is configured to purchase, reduce, add, and cancel power use through the smart mobile device, and to perform functions including instant messaging, online payment, and monitor screen watching through the smart mobile device.

6. The intelligent off-peak power distribution system of claim 5, wherein the distribution vehicle comprises a smart electronic device which is communicated with the smart communication network to display the instant driving path and the estimated arrival time of the distribution vehicle, and the amount of the batteries needed by each power consumption end.

7. The intelligent off-peak power distribution system of claim 3, wherein the lighting fixture comprises a luminous module and a control unit, and the control unit is configured to switch the light emitted by the luminous module between a first light beam and a second light beam; the circadian stimulus/photometry of the second light beam is smaller than that of the first light beam, and the color temperature of the second light beam is essentially the same as that of the first light beam; at least one wavelength peak of the first light beam is between 420 nm and 480 nm, and at least one wavelength peak of the second light beam is between 480 nm and 540 nm.

8. The intelligent off-peak power distribution system of claim 3, wherein each of the distribution vehicle and the power supply end has a plurality of electricity cabinets, and the distribution vehicle is adapted to record or transmit the information of the power levels of the batteries through the electricity cabinet; the distribution vehicle is equipped with a GPS system that is configured to locate the distribution vehicle and transmit the information of power levels of the batteries obtained through the corresponding electronic codes and the location of the distribution vehicle to the smart communication network; the batteries are charged by the power supply end through the electricity cabinet, and the electricity cabinet is configured to be moved and replaced among the power consumption ends, the distribution vehicle, and the power supply end.

9. The intelligent off-peak power distribution system of claim 8, wherein the distribution vehicle has a charging base which is adapted to electrically connect to the electricity cabinet loaded on the distribution vehicle, and the charging base is configured to directly charge all of the batteries in the electricity cabinet; the distribution vehicle is adapted to externally connect to a charging plug through the charging base for emergency charging and off-peak charging, and the charging plug is configured to be set in a relay charging station which provides a place for the distribution vehicle to charge the batteries during distribution; the charging plug is adapted to be set in the house of deliverer to perform off-peak charging at night.

10. The intelligent off-peak power distribution system of claim 1, wherein when the total remaining power of the power consumption end is lower than a preset proportion, the power-saving mode of the power consumption end is automatically triggered, or the power-saving mode of the power consumption end is started by the smart communication network after the smart communication network estimates the arrival time of the distribution vehicle; the power-saving mode is adapted to reduce each power load of the power consumption end or to rest partial power loads of the power consumption end, so as to extend the service time of the power consumption end and enable the distribution vehicle to have more time to adjust the distribution planning.
